(19) United States
(12) Patent Application Publication
(10) Pub. No.: US 2006/0119471 A1
(43) Pub. Date: Jun. 8, 2006

(54) Materials handling, tracking and control system

(76) Inventors: Richard F. Rudolph, Mason, OH (US); Ernest A. Elliot, Villa Hills, KY (US); Mark A. Mathews, Cincinnati, OH (US)

Correspondence Address: INTERNATIONAL PAPER COMPANY, 6285 TRI-RIDGE BOULEVARD, LOVELAND, OH, 45140, US

(21) Appl. No.: 09/837,351

(22) Filed: Apr. 17, 2001

Related U.S. Application Data
(60) Provisional application No. 60/197,896, filed on Apr. 17, 2000.

(51) Int. Cl. H04Q 5/22

(52) U.S. Cl. 340/10.41; 340/10.51; 340/572.1

(57) ABSTRACT

A product information system comprises a product package, container or support having an RFID tag including data memory means for storing at least a unique digital identification code for the product and at least one remote storage access code, including a URL, for accessing additional dynamic and/or static data associated with the product which is stored outside the tag and container, the system being operative to retrieve the identification code and remote access code and to access the additional data via the Internet.

### RELATED APPLICATION

This application claims the priority of U.S. Provisional Application No. 60/197,896, filed Apr. 17, 2000 which is herein incorporated by reference.

### FIELD OF THE INVENTION

This invention relates to the field of packaging, and more particularly to a product container, support and/or packaging which is provided with capabilities to interface with computer systems and database systems to facilitate handling, tracking and control of packaged products.

### BACKGROUND OF THE INVENTION

Currently, there often is a need to access a significant amount of MSDS (Material Safety Data Sheet) information associated with products as they move through their life cycles. There is a need to associate accurate and up to date MSDS information and product tracking information of various types with either a type of product or even with a specific individual item of that type. Data retrieval and association (tracking) of specific, correct types and items of product are often arduous, time consuming, error prone and sometimes impossible tasks with currently available systems.

### SUMMARY OF THE INVENTION

The present invention relates to a system utilizing an RFID (Radio Frequency IDentification) tag, wherein the RFID tag provides one or more links, for example, either locally or via the Internet, to MSDS or other dynamic or fixed information databases for one or many products, including individual items of one or many particular types of products.

### BRIEF DESCRIPTION OF THE DRAWING

A more complete understanding of the present invention may be obtained from consideration of the following description in conjunction with the drawing in which:

FIG. 1 is a functional diagram of a system according to the present invention in which local and remotely stored product information is accessed;

FIG. 2 is a functional diagram of a system according to the invention in which locally stored product information is accessed, and

FIG. 3 is a functional diagram of a Radio Frequency Identification system employing the present invention.

### DETAILED DESCRIPTION

Although the present invention is particularly well suited for tracking product movement and retrieving MSDS and product information, and will be so described, the present invention is equally well suited for use where accurate and up to date information of other types is to be associated with a particular product type or item.

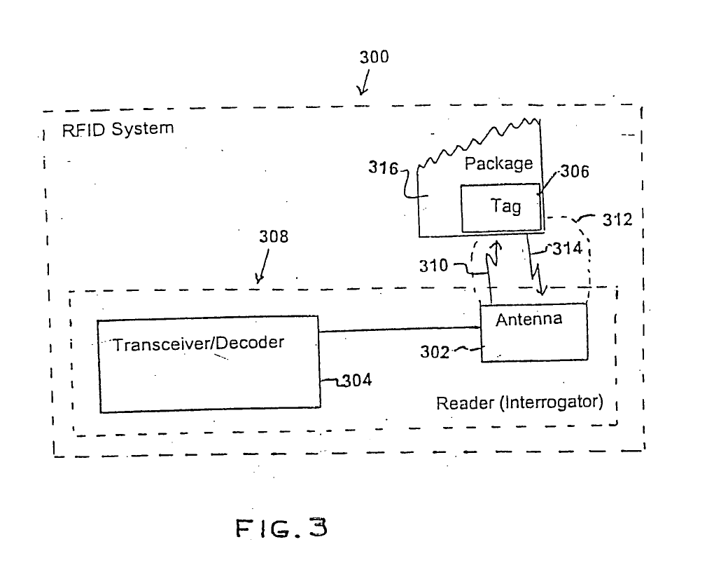

Referring to FIG. 3, a Radio Frequency Identification (RFID) system 300 employing the present invention comprises a coil or other type of antenna 302, a transceiver (with decoder) 304, and a transponder (commonly called an RFID tag) 306 programmed with unique stored information (data). The identification tag 306 contains encoded data corresponding to a unique item identification code along with a limited amount of other product related and/or “lookup” data.

The antenna 302 typically receives and sends radio frequency signals to activate tag 306 and to read and write data to and from the tag 306. Antenna 302 may be any one of a variety of shapes and sizes. For example, antenna 302 can be built into a doorway to receive tag data from or to write data to product containers, supports, packages or other things passing through the doorway. An electromagnetic field produced by antenna 302 can be constantly present when multiple tags may be expected to pass through the doorway in a more or less continuous or regular stream. If constant interrogation is not required, a sensor device may be provided to activate the field when required (for example, when an item approaches the threshhold).

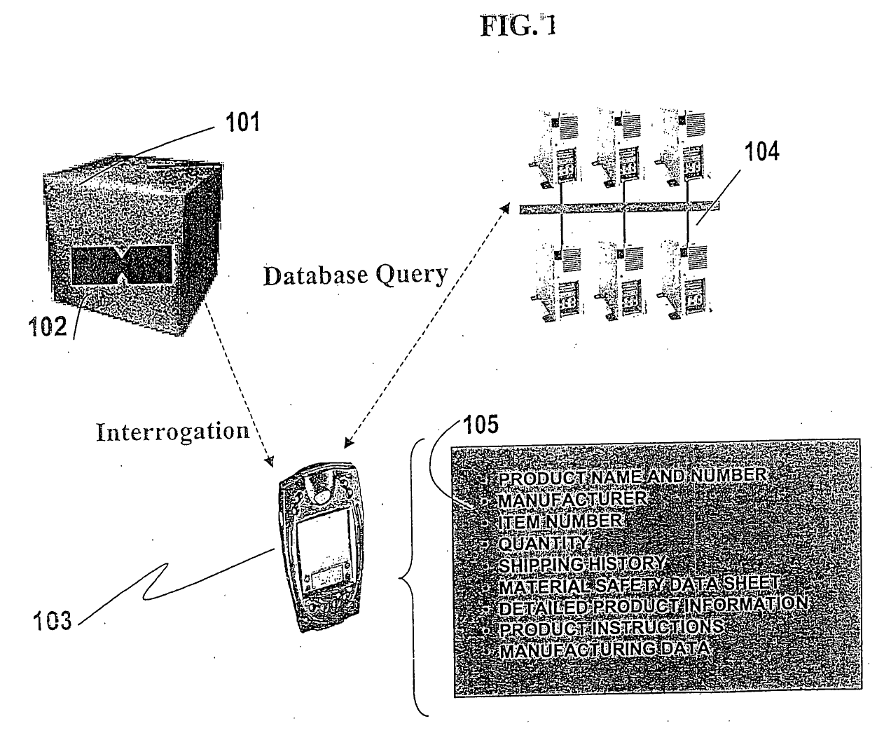

Often the antenna 302 is configured with the transceiver/decoder 304 to become a reader (interrogator) 308, which can be configured, for example, as a hand held or a fixed-mount device. The reader 308 emits radio frequency waves 310 across distances of anywhere from one inch to one hundred feet or more, depending on the signal power output and the operational radio frequency used. When an RFID tag 306 passes through an electromagnetic sensing zone 312, tag 306 detects the activation signal of reader 308 and responds by emitting code-containing radio frequency waves 314. Tag 306 itself may include an antenna (see, for example, FIG. 1 and related discussion below). The reader 308 decodes the data encoded in an integrated circuit (memory) of RFID tag 306 and the data is passed to a host computer (see FIG. 1) for processing.

RFID tag 306 may come in a wide variety of shapes and sizes. RFID tag 306 may be categorized as either passive or active. Active RFID tags 306 may be powered by an internal battery (not shown) and typically have read/write capabilities; i.e. tag data can be rewritten or modified. The memory capacity of an active tag 306 will differ according to application requirements. Some RFID systems operate, for example, with 1 MB of internal memory. In a typical read/write RFID system 300, a tag 306 can provide a set of instructions or information and the tag 306 can receive and store encoded information. This encoded information or data then becomes part of the recorded history of the tagged product 316. The battery power of an active tag 306 generally gives it a greater read range. The trade off is greater size, higher cost and a more limited operating life.

Passive RFID tags 306 operate without a separate external power source and obtain operating power from the reader 308. Passive tags 306 consequently are usually lighter in weight than active tags 306, are less expensive and offer a theoretically unlimited operational lifetime. A trade off is that passive tags 306 generally have a smaller read range than active tags and typically require a higher powered reader.

Read-only tags 306 typically are passive and are programmed with a unique set of data (usually 32 to 128 bits) that cannot be modified (write once). Read-only tags 306 most often serve as a key or index into a database in much the same way as a barcode references a database which contains modifiable product-specific information.

Frequency ranges also distinguish RFID systems 300. Low frequency (30 KHz to 500 KHz) systems typically have short reading ranges and lower system costs. These low frequency systems are most commonly used in security, access, asset tracking and animal identification applications. Higher frequency (850 MHz to 950 MHz and 2.4 GHz to 2.5 GHz ) systems typically offer long read ranges (greater than ninety feet) and higher reading rates.

A significant advantage of RFID systems 300 is the non-contact, non-line-of-sight nature of the technology. Tags 306 can be read through a variety of conditions such as snow, fog, ice, paint, crusted grime, and other visually and environmentally challenging conditions where barcodes or other optically read technologies would be at a disadvantage. RFID tags 300 can also be read in challenging situations at high rates, responding in typical cases in on the order of one hundred milliseconds.

The range that can be achieved with an RFID system 300 is determined essentially by power available at the reader/interrogator 308 to communicate with tag 306, power available within the tag 306 to respond and environmental conditions, including surrounding structures.

In FIG. 1, a materials handling, tracking and control system according to one embodiment of the present invention is illustrated. As is shown in FIG. 1, an RFID tag 102 is attached to a product support or package or container 101. The RFID tag 102 contains a stored, unique identification code and stored product reference information. The latter may be used to trigger a database query in the form of an HTML (Hyper Text Markup Language) link via the Internet to a remotely located MSDS or other product-related information database 105 stored in one or more Internet web servers or database servers 104. Database 105 contains, for example, product name and/or number, manufacturer's name, item serial number, quantity in the package 101, shipping history (which is updated over time), Material Safety Data Sheet information (similarly updated), detailed product information, product operating instructions, manufacturing data and such other information as may be of value to a manufacturer, warehouseman, wholesaler, etc. in the chain of commerce. As indicated, the MSDS and other data in database 105 can be updated and maintained accurate, in contrast to physical MSDS documents attached to a product at the time of manufacture which is current, at best, as of the date of printing. By means of an interrogator/reader 103, the RFID tag 102 is activated so that the MSDS or other information in database 105 may be accessed quickly in the event of an occurrence such as an accident or emergency. Information necessary for a HAZMAT response or for use by rescue, fire, emergency medical or clean up personnel can be available immediately and with a high confidence factor as to accuracy. Even in compromised conditions such as darkness, smoke, or cold, the MSDS or other information can be accessed without physical contact or undue proximity to the package or container 101.

In one sequence of warehouse operations, such as at a production site, upon packing of container 101, a label including a conventional optical barcode and text, is applied to container 101. As part of the labeling process, Internet URL (Uniform Resource Locater) data pertaining to each package (item) 101 is stored in a database either at the place where labeling occurs or on an Internet server 104 accessible from that location. Typically, an operator optically reads the barcode on each item received and, using a scanner, determines the URL and other product identifying information to be written on RFID tag 102. The scanner transmits the data to an RFID writer to produce the smart label on package 101. Alternatively, the RFID tag 102 and associated barcode label are produced as an integral step in the manufacturing process of the container 101 itself, using similar steps and information sources as described above.

The RFID tag 102 typically contains a unique identification number, a URL address, a “From” field to identify the source of the package 101 and a “To” field to identify its destination. The URL address on tag 102 will automatically connect a user to a website which provides information such as trade name, manufacturer, product number, quantity per package, etc. Updated MSDS information may also be provided at the website. Tracking information such as SKU, serial number, container type, weight, customer purchase order number (where applicable), history of storage locations, dates and times, names of operators, and a host of other pertinent information readily may be stored remotely and made accessible locally as needed. With respect to manufacturing data, items such as date of manufacture, plant location and number, line number, lot number, warranty information and of the order of ten to twenty user customizable fields for additional information may be provided. Additional information such as product specifications, quality control testing, directions for use, repair information or spare parts ordering may also be included, all within the storage capabilities of the system.

Warehouse operators and customers will be able to interrogate RFID tag 101 using, for example, at least two different types of hand held terminals 103 (HHT). A “basic” HHT 103 is contemplated as a wireless terminal having a display and the capability to connect to the Internet. HHT 103 also contains an RFID reader/writer. Such a terminal 103 is primarily for use in a warehouse after a product container 101 is received for put-away and picking operations. Such a basic HHT 103 displays fields such as task number, task type (pick or put-away), item requested, quantity requested, location, operator number, date and time. An “advanced” HHT is also contemplated which has all of the features of the basic HHT and, in addition, can access the full Internet database for information such as product information, MSDS, tracking, manufacturing data, specifications, quality control data and ability to order additional product. The advanced HHT may also be linked to a hard copy device, if desired.

Different levels of access and ability to write or enter data can be controlled by means of operator ID information and password or PIN information in a customary manner for handling databases. Warehouse operators can be directed by the Basic HHT to pick and put-away locations, as well as to other locations on site such as truck bay or loading dock. Correct location can be confirmed in a mapped site by means of, for example, red and green pilot lights appearing on the Basic HHT as location changes. Operators can update the new “to” location and the system stores the “from” location as the prior “to” location. The item's current movement can be preserved on tag 102 itself to insure accurate location information availability even when Internet access is not available.

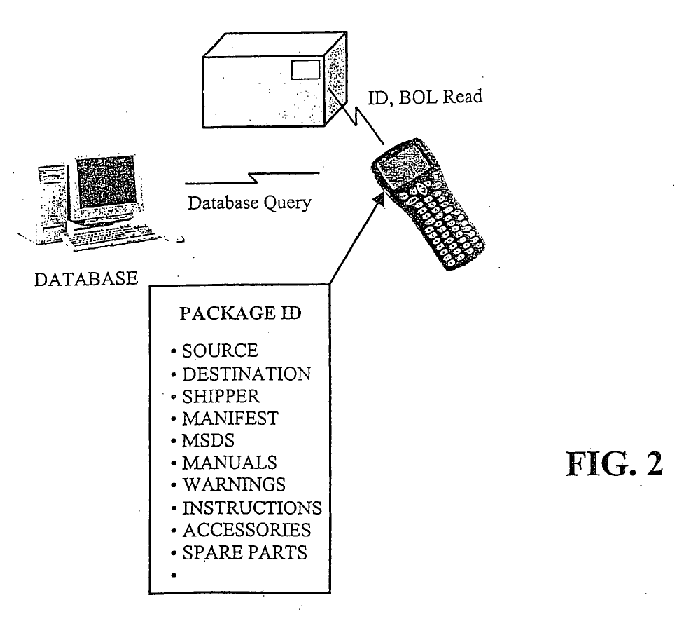

As shown in FIG. 2, the RFID tag 102 may carry an additional small amount of frequently used data, with access to other information being obtained through associated local or remote databases outside of the package, support, container or product itself.

While the various aspects of the invention have been described in connection with certain preferred embodiments, it should also be apparent that modifications may be made within the scope of the foregoing without departing from the broadest aspects of the invention as set forth in the following claims. Accordingly, this description is to be construed as illustrative only and is for the purpose of teaching those skilled in the art the best mode of carrying out the invention as currently contemplated. Details of the structure and its operation may be varied without departing from the invention.

1. A product information system comprising:
a product container;
an RFID tag associated with said container having data memory means for storing at least a unique digital identification code for said container and at least one remote storage access code for accessing additional data associated with said container and stored outside said tag memory means wherein the RFID tag includes at least two read or write updatable fields in said tag memory that contain data being associated therewith; and
means for retrieving said unique digital identification code said remote access storage code from said memory means.

2. A product information system according to claim 1 wherein:
said means for retrieving comprises an interrogator for accessing said memory of said tag and for utilizing said identification code and said remote storage access code to retrieve information uniquely associated with said container.

3. A product information system according to claim 2 wherein:
said uniquely associated information comprise Material Safety Data Sheet (MSDS) information for contents of said container.

4. A product information system according to claim 3 wherein:
said MSDS information is updated and is stored remotely from said product container.

5. A product information system according to claim 4 wherein:
said interrogator is coupled via an internet connection to said updated MSDS information.

6. A product information system according to claim 5 wherein:
said interrogator is coupled via said Internet connection to at least one data processor which has access to MSDS information for at least one or a plurality of products.

7. A product information system according to claim 6 wherein:
said interrogator further has a access to historical information uniquely associate with said container as identified by its unique digital identification code.

8. A product information system according to claim 7 wherein:
said interrogator has access to manufacture's information uniquely associated with each of a plurality of container.

9. A method of providing accessible product related information uniquely associated with each product container comprising:
placing an RFID tag an Internet product container, said tag having a unique coded identifier for each said container;
storing in said RFID tag additional historical information unique to said product container; and
interrogating said RFID tag and coupling to an internet connection to provide unique historical information relating to the specific container and its product contents and wherein the RFID tag includes at least two read or write updatable fields in said tag memory that contain data being associated therewith.

10. A method of providing product information according to claim 9 wherein:
said historical information is selected from the group consisting of MSDS, Manufacturer's identity, date of manufacture, product number, item serial number and history of storage locations for said container.
